(19) United States
(12) Patent Application Publication
(10) Pub. No.: US 2026/0155975 A1
(43) Pub. Date: Jun. 4, 2026

(54) OPERATING METHOD OF SECURITY SYSTEM IN ENVIRONMENT IN WHICH USER INFORMATION RECEIVING DEVICE AND KEY SECURITY DEVICE ARE SEPARATED

(71) Applicants: AIRCUVE INC., Seoul (KR); SHINAN INFORMATION COMM. CO., LTD, Gunpo-si, Gyeonggi-do (KR)

(72) Inventors: You Serk HAN, Gimpo-si (KR); Youn Joo CHANG, Seoul (KR); Ki Chel JU, Seoul (KR)

(73) Assignees: AIRCUVE INC., Seoul (KR); SHINAN INFORMATION COMM. CO., LTD, Gunpo-si, Gyeonggi-do (KR)

(21) Appl. No.: 18/724,397

(22) PCT Filed: Jun. 12, 2023
(86) PCT No.: PCT/KR2023/008067

§ 371 Date: Jun. 26, 2024

(30) Foreign Application Priority Data
Jun. 12, 2023 (KR) 10-2023-0074632

(51) Int. Cl. H04L 9/32; H04L 9/08

(52) U.S. Cl. CPC H04L 9/3213; H04L 9/0866

(57) ABSTRACT

An operating method of a security system for authenticating a user on the basis of fast identity online (FIDO) according to an embodiment of the present disclosure includes: receiving first user information through a user information receiving device connected to a key security device; storing feature information generated on the basis of the first user information in the key security device; receiving second user information of which authentication is requested through the user information receiving device; and receiving a token for allowing user access from a FIDO server in response to a case in which the key security device determines that authentication feature information generated on the basis of the second user information matches the feature information.

### TECHNICAL FIELD

The technical spirit of the present disclosure relates to a security system, and more particularly, to a security system in an environment in which a user information receiving device and a key security device are separated.

### BACKGROUND ART

With the rapid spread of cloud-based information technology (IT) environments in corporations, it is necessary to change a user identification and authentication system from the perspective of securing access to IT environments in corporations. This is access security for an environment in which the physical location of a user and the physical location of property accessing an IT environment are outside of a corporation, and thus it is necessary to change conventional access security systems that manage the physical environments of networks to keep them secure.

The most important management factor in this change of security environments is to establish the basis of trust in accessing users while controlling the environments of various user devices and network connectivity from a zero-trust perspective. The fast identity online 2(FIDO2 ) standards promoted by the FIDO Alliance are an authentication security technology for user reliability in a cloud environment that is already employed in many terminals and browsers and adopted by many possession-based security key manufacturers.

When FIDO authentication is performed using a possession-based security key, a fingerprint sensor may be built so that only users with registered fingerprints can use the security key. FIDO allows user presence attestation in various ways, but when a possession-based security key is used, it is generally necessary to implement the function on limited hardware (H/W). Accordingly, FIDO is limited in practice to a method for which a fingerprint sensor or the like is built.

### DISCLOSURE

### Technical Problem

The problem to be solved by the technical spirit of the present disclosure is to provide a security system for supporting a plurality of types of authentication methods.

### Technical Solution

An operating method of a security system for authenticating a user on the basis of fast identity online (FIDO) according to an embodiment of the present disclosure includes: receiving first user information through a user information receiving device connected to a key security device; storing feature information generated on the basis of the first user information in the key security device; receiving second user information of which authentication is requested through the user information receiving device; and receiving a token for allowing user access from a FIDO server in response to a case in which the key security device determines that authentication feature information generated on the basis of the second user information matches the feature information.

A security system according to an embodiment of the present disclosure includes: a relying party (RP) service module configured to generate feature information from first user information received through an authentication device; and a key security device connected to the RP service module to store the feature information and configured to determine whether authentication feature information generated on the basis of second user information, of which authentication is requested through the authentication device, matches the feature information. The key security device blocks access from an external device to a storage region in which the feature information is stored.

### Advantageous Effects

In a security system according to an embodiment of the present disclosure, a user inputs user information to a terminal that is currently accessing the security system, and thus additional security control can be performed according to the location of the terminal. Also, a key security device interoperates with a smartphone through a simple user information input interface, such as a fingerprint sensor, a camera, a keypad, or the like, or is installed in the form of an application and executed, and thus a fast identity online (FIDO) standard security system can be applied to a legacy information technology (IT) environment.

In addition, a key security device according to an embodiment of the present disclosure can store security keys using a plurality of types of authentication methods, and thus it is possible to expand the application range of FIDO authentication.

Effects of the exemplary embodiments of the present disclosure are not limited those described above, and other effects which have not been described will be clearly derived and understood by those skilled in the technical field to which the exemplary embodiments of the present disclosure belong from the following description. In other words, unintended effects of implementing the exemplary embodiments of the present disclosure may be also derived from the exemplary embodiments of the present disclosure by those of ordinary skill in the art.

### DESCRIPTION OF DRAWINGS

FIG. 1 is a block diagram of a security system according to an embodiment of the present disclosure.

FIG. 2 is a block diagram of a user information receiving device according to an embodiment.

FIG. 3 is a block diagram of a key security device according to an embodiment.

FIG. 4 is a sequence diagram illustrating a method of storing feature information in a key security device of a security system according to an embodiment.

FIG. 5 is a sequence diagram illustrating a method of registering user authentication information in a fast identity online (FIDO) server according to an embodiment.

FIG. 6 is a sequence diagram illustrating a method of storing feature information in a key security device according to an embodiment.

FIG. 7 is a sequence diagram illustrating a method of performing FIDO authentication in a security system according to an embodiment.

FIG. 8 is a sequence diagram illustrating a method of acquiring a matching result between authentication feature information and feature information from a key security device according to an embodiment.

FIGS. 9 and 10 are diagrams illustrating an embodiment of registering relying party (RP) server information and a user on a key management server.

FIG. 11 is a set of views illustrating an embodiment of selecting a type of authentication in an RP server according to an embodiment.

FIG. 12 is a set of views illustrating an embodiment of registering feature information in a key security device and storing user authentication information corresponding to the feature information in a FIDO server.

FIG. 13 is a set of views illustrating an embodiment of registering feature information in a key security device using a different authentication method than in FIG. 12.

FIGS. 14 and 15 are sets of views illustrating different embodiments of authenticating a user.

### BEST MODE OF THE INVENTION

An operating method of a security system for authenticating a user on the basis of fast identity online (FIDO) according to an embodiment of the present disclosure may include: an operation of receiving first user information through a user information receiving device connected to a key security device; an operation of storing feature information which is generated on the basis of the first user information in the key security device; an operation of receiving second user information of which authentication is requested through the user information receiving device; and an operation of receiving a token for allowing user access from a FIDO server in response to a case in which the key security device determines that authentication feature information generated on the basis of the second user information matches the feature information.

### MODES OF THE INVENTION

Hereinafter, embodiments of the present disclosure will be described in detail with reference to the accompanying drawings.

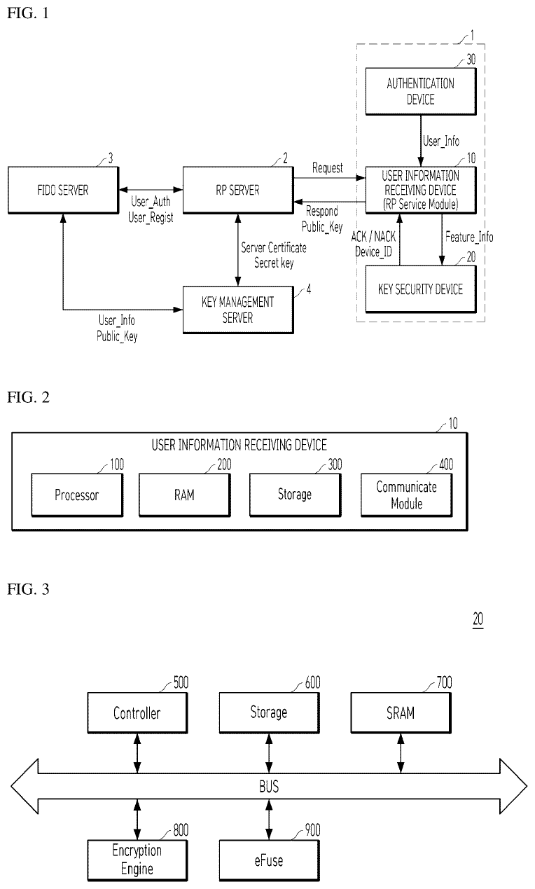

FIG. 1 is a block diagram of a security system according to an embodiment of the present disclosure.

Referring to FIG. 1, the security system according to the embodiment of the present disclosure may include a relying party (RP) server 2, a user-end module 1, a fast identity online (FIDO) server 3, and a key management server 4. Here, the user-end module 1 may include an authentication device 30, a user information receiving device 10, and a key security device 20.

According to an embodiment, the RP server 2 may be connected to the user information receiving device 10 and perform user identification and authentication through FIDO authentication. When the security system performs web-based authentication, the RP server 2 may perform FIDO registration and authentication on a web authentication page in which a user presence attestation function is implemented in addition to FIDO2 functions of a web authentication (WebAuthn) application programming interface (API). Here, the user-end module 1 operates according to code (an RP service module) that is implemented to be called through a web browser. When the security system does not perform web-based authentication, a FIDO application (APP) may be installed on the user information receiving device 10, and the user presence attestation function may be integrated with the FIDO APP to perform FIDO registration and authentication.

In the present specification, the RP service module may be described as a system including the RP server 2 and the user information receiving device 10. The RP service module may relay user information received from the authentication device 30 and information provided by the key security device 20.

The user information receiving device 10 may generate feature information on the basis of the user information. The feature information may be information for specifying an individual user, which is information based on bio-information, such as a fingerprint, the face, the voice, or the like, or information generated from input information that is considered to be known only to the individual.

The key management server 4 may store a public key corresponding to a private key which is generated when FIDO authentication and registration are performed. The public key stored in the key management server 4 may be mapped to information on a user and stored. The public key stored in the key management server 4 may be used for distributing and verifying a certificate which is a means of encryption and trust for coping with additional security threats when a user presence attestation procedure is performed by a device out of the key security device 20. In addition, the public key stored in the key management server 4 may be distributed to a specific user, or product information of a user's own private key or the like may be checked to improve convenience in asset management.

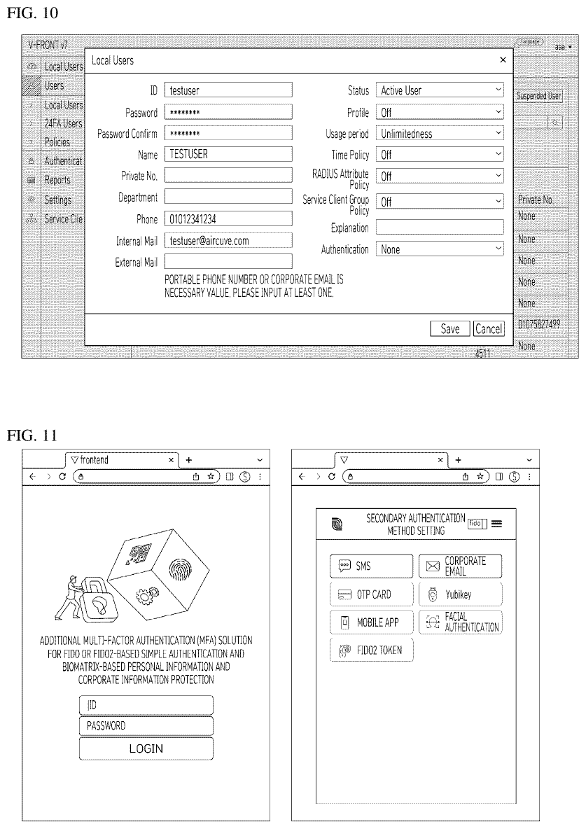

Before FIDO authentication is performed, a manager of an RP service may access a FIDO management function through the RP server 2 as shown in FIGS. 9 and 10 to register information on the RP server 2 or the user information receiving device 10, which is required to perform FIDO authentication, on the FIDO server 3 and may generate connection information and a server certificate required for a trusted connection during FIDO authentication.

When a FIDO authentication request is received from the user-end module 1, the RP server 2 transmits necessary information of the RP server 2 or the user information receiving device 10 to the FIDO server 3 through a registration request process.

The user may connect the key security device 20 to the user information receiving device 10 and request a FIDO authentication service through a service APP implemented in the user information receiving device 10 or a webpage. The user information receiving device 10 according to the embodiment of the present disclosure may be any type of device compatible with the key security device 20. When the user information receiving device 10 and the key security device 20 are connected, the key security device 20 may provide device information to the user information receiving device 10, and the user information receiving device 10 may provide feature information for specifying the user to the key security device 20.

The connection between the user information receiving device 10 and the key security device 20 may represent wired connection through a Universal Serial Bus (USB) or a cable. However, embodiments of the present disclosure are not limited thereto, and the user information receiving device 10 and the key security device 20 may be connected through a short-range communication interface of Bluetooth, near field communication (NFC), Wi-Fi, or the like. In the case of connecting the user information receiving device 10 and the key security device 20 through a short-range communication interface, the connection may be established by the user simply carrying the key security device 20 without performing any connection operation.

The RP service module which receives the user request may perform a FIDO authentication process according to a set FIDO authentication procedure. The RP service module may detect the key security device 20 carried by the user, receive user information according to a user presence attestation method (a personal identification number (PIN) code, a touch, a gesture, a fingerprint, face recognition, voice recognition, or the like) defined in the key security device 20, and transmit the user information to the key security device 20 as authentication feature information. When the authentication feature information corresponds to a previously registered security key, the key security device 20 may generate and transmit response information for FIDO authentication to the FIDO server 3.

When the detected key security device 20 is used for the first time, the security system may perform a user registration procedure using the FIDO server 3 and then perform FIDO authentication using the registered security key.

The security system of the present disclosure may employ various user presence attestation methods according to the type of user information receiving device 10 that accesses the RP service environment or an installed user interface and may simultaneously require a plurality of methods to perform an enhanced user identification function.

In other words, the security system of the present disclosure may generate distinguishable feature information from user information received from different authentication devices 30, and the distinguishable feature information may be stored in different storage regions of the key security device 20, which allows the single key security device 20 to perform the user identification function in a plurality of ways.

As an example, the security system of the present disclosure may receive user face information from a face photographing device and generate feature point information of the user face information as feature information. The security system may receive user fingerprint information from a fingerprint sensing device and generate feature point information of the user fingerprint information as feature information. The key security device 20 may store the feature information generated from the user face information and the feature information generated from the user fingerprint information in different storage regions, and the security system of the present disclosure may support different types of authentication methods through the single key security device 20.

Although the user information received through the authentication device 30 may be bio-information including the user face information and the user fingerprint information, user information of the present disclosure is not limited thereto but may include fingerprint information, face information, iris information, and vein information. Also, the user information is not limited to bio-information but may include personal identification number (PIN) information or pattern information directly input by the user. According to an embodiment, an RP service module may generate feature information on the basis of the received user information and discard the feature information, which is at least temporarily stored in the RP service module, after the feature information is transmitted to the key security device 20. Also, the key security device 20 can prevent the feature information from being read by an external device by blocking access to a storage region in which the feature information is stored by any external device including the RP service module.

Accordingly, the security system of the present disclosure can employ various user presence attestation methods. Conventional security systems cannot support various authentication methods due to hardware limitations on the key security device. On the other hand, according to the security system of the present disclosure, user presence attestation may be performed by the RP service module combined with the user information receiving device 10, feature information may be stored in the safe key security device 20, and the key security device 20 may match the feature information with authentication feature information and only provide the matching result to the RP service module.

In addition, conventional security systems are at risk of leaking personal information from shared user workstations, but in the security system of the present disclosure, the RP service module provides an input interface only for user presence attestation, and acquired personal information is only stored in the key security device 20 and then discarded to minimize the risk of leaking the personal information.

According to an embodiment, the user information receiving device 10 and the key security device 20 of the security system of the present disclosure may be connected through a short-range communication interface. Accordingly, the user can perform user authentication simply by carrying the key security device 20, which improves user convenience.

According to an embodiment, in the security system of the present disclosure, the RP service module encrypts feature information, and the key security device 20 directly decrypts the feature information. Therefore, even when the feature information is seized in a feature information transmission and reception process between the RP service module and the key security device 20, it is possible to minimize the risk of leaking the feature information.

FIG. 2 is a block diagram of the user information receiving device 10 according to the embodiment.

The user information receiving device 10 may include a processor 100, a random access memory (RAM) 200, a storage 300, and a communication module 400. When the user information receiving device 10 communicates with a plurality of devices, the user information receiving device 10 may be referred to as a user terminal that may transmit and receive data and information to and from the plurality of devices. As an example, the user information receiving device 10 may include a mobile phone, a smartphone, a tablet personal computer (PC), a wearable device, a healthcare device, or an Internet of things (IOT) device.

The processor 100 may control overall operations of the user information receiving device 10. The processor 100 may be a central processing unit (CPU) including a single-core processor or a multi-core processor. The user information receiving device 10 may include one or more processors 100.

The processor 100 may process or execute programs, data, or instructions stored in the storage 300. For example, the processor 100 may execute the programs stored in the storage 300 to generate feature information from user information. In addition, the processor 100 may generate data packets to communicate with the key security device 20 and the RP server 2 according to a preset protocol.

The RAM 200 may temporarily store programs, data, or instructions. For example, the programs and/or data stored in the storage 300 may be temporarily stored in the RAM 200 according to control of the processor 100 or a booting code. For example, the RAM 200 includes a dynamic RAM (DRAM), a static RAM (SRAM), a synchronous DRAM (SDRAM), or the like.

The storage 300 is a storage place for storing data and may store an operating system (OS), various programs, and various data. The storage 300 includes a read only memory (ROM), a flash memory, a phase-change RAM (PRAM), a magnetic RAM (MRAM), a resistive RAM (RRAM), a ferroelectric RAM (FRAM), and the like. According to an embodiment, the storage 300 may be implemented as a hard disk drive (HDD), a solid state drive (SSD), or the like.

The communication module 400 may transmit and/or receive data of the user information receiving device 10. For example, the communication module 400 may transmit and receive data using various communication methods. The communication module 400 may perform communication using, for example, third generation (3G), Long Term Evolution (LTE), Wi-Fi, Bluetooth, Bluetooth Low Energy (BLE), ZigBee, NFC, ultrasonic, and more communication methods and perform all of wired communication, wireless communication, short-range communication, and long-range communication.

Therefore, the user information receiving device 10 of the present disclosure may perform an operation using the components and temporarily store data or instructions or transmit and/or receive data to and/or from other user information receiving devices 10. The user information receiving device 10 of the present disclosure is a device controlled by the user, and the RP server 2 is a device controlled by a security manager. The RP server 2 may include components that perform the same operations as those of the user information receiving device 10, only differing in the management entity.

FIG. 3 is a block diagram of the key security device 20 according to the embodiment.

Referring to FIG. 3, the key security device 20 may transmit or receive information through a bus. The key security device 20 may include a controller 500, a storage module 600, an SRAM 700, an encryption engine 800, and an electronic fuse (eFuse) 900. Each of the components may be connected to at least one bus to transmit and receive information.

Specifically, the controller 500, the storage module 600, the SRAM 700, the encryption engine 800, and the eFuse 900 may transmit and receive data and control information therebetween through the bus. As an example, the protocol of the bus may be implemented as any one of an advanced high performance bus (AHB), an advanced system bus (ASB), an advanced peripheral bus (APB), and an advanced extensible interface (AXI). However, the protocol of the bus is not limited thereto but may include any type of bus protocol for bidirectionally transmitting and receiving data and control information.

The AHB may be a bus for connecting devices that operate at a high rate, and may operate as a multiplex bus base for sharing an address line, a control line, and even a data line. The ASB may be a bus that operates at a high rate, uses both rising edges and falling edges, and involves an address line, a control line, and a data line separated from each other. The APB is a bus for controlling peripherals with a relatively low rate and may have a simple interface to reduce the power consumption of the key security device 20.

The controller 500 may be referred to as a processing unit and include a core that may execute any instruction set (e.g., Intel Architecture-32 (IA)-32, 64-bit expansion IA-32, x86-64, PowerPC, Sparc, microprocessor without interlocked pipeline stages (MIPS), advanced reduced instruction set computer (RISC) machines (ARM), IA-64, or the like) such as a microprocessor, an application processor (AP), a digital signal processor (DSP), or a graphics processing unit (GPU).

The controller 500 of the key security device 20 may control the key security device 20 so that feature information transmitted from the user information receiving device 10 is stored in the storage module 600. In addition, the controller 500 may load the feature information stored in the storage module 600 and compare the feature information with authentication feature information received from the user information receiving device 10 to determine whether to transmit an ACK signal or a NACK signal to the user information receiving device 10.

The storage module 600 may store the feature information. Here, the feature information may be acquired by decrypting encrypted feature information on the basis of the device information of the key security device 20. The storage module 600 may transmit and receive data to and from the bus through a quad serial peripheral interface (QSPI) cache. The QSPI cache may have four half-duplex data transmission lines. In other words, parallel transmission is performed through the four data lines, and thus QSPI may have four times the transmission rate of SPI (40 Mbps). The high transmission rate may particularly increase a booting speed.

The SRAM 700 may temporarily store data. According to an embodiment of the present disclosure, the key security device 20 may temporarily store data in the SRAM 700. However, the data storage is not limited to the SRAM but may include a volatile memory such as a DRAM, an RRAM, an MRAM, a PRAM, or the like. The SRAM 700 may receive the encrypted feature information and encrypted authentication feature information from the user information receiving device 10, store the encrypted feature information and the encrypted authentication feature information, and transmit the encrypted feature information and the encrypted authentication feature information to an encryption engine 800 through the bus. The SRAM 700 may receive the feature information and authentication feature information decrypted through the encryption engine 800 and provide the decrypted feature information and authentication feature information to the storage module 600.

The encryption engine 800 generates authentication data according to the FIDO standards and transmits a public key, which is generated according to an asymmetric key generation algorithm, in response to a FIDO registration request in the case of registering a user. Also, the encryption engine 800 may decrypt the feature information and authentication feature information that is encrypted by the RP service module. Here, the encryption engine 800 may perform the decryption operation using the device information of the key security device 20 as a decryption key value. As an example, the encryption engine 800 may perform encryption and decryption according to the advanced encryption standard (AES) for performing encryption and decryption on the basis of an encryption key value and a decryption key value.

The eFuse 900 may be referred to as an electronic fuse and store the device information of the key security device 20. The device information of the key security device 20 may be an identification number that is generated for each key security device 20, and a unique number that is given in advance in the manufacturing process of the key security device 20. When the eFuse 900 detects an external device's attempt to seize the device information, the eFuse 900 may delete all data stored therein as well as the device information. The eFuse 900 may store a user key value and a platform key value in addition to the device information. The user key value may be information on the user who stores user information in the key security device 20, and information registered in the key security device 20 for the FIDO server 3 to identify the user. The platform key value may be information for identifying the RP service module.

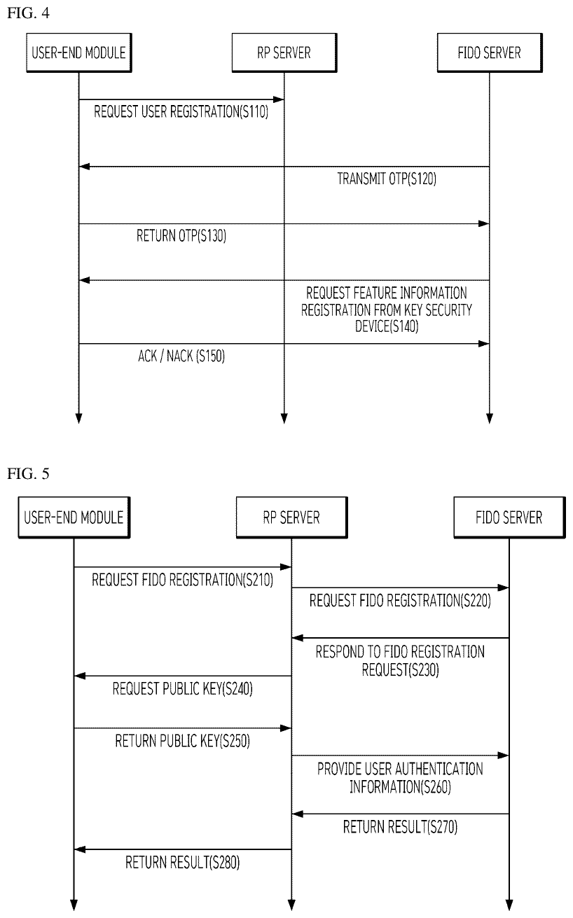

FIG. 4 is a sequence diagram illustrating a method of storing feature information in the key security device 20 of the security system according to an embodiment.

Referring to FIG. 4, the security system of the present disclosure may perform user authentication while transmitting and receiving data and information between the user-end module 1 and the FIDO server 3. Here, the FIDO server 3 may instruct the user-end module 1 to store feature information in the key security device 20.

In operation S110, the user-end module 1 may request user registration from the RP server 2 to register the key security device 20 and a user on the FIDO server 3. When the user executes a browser in his or her terminal to call a specific service uniform resource locator (URL), the corresponding service may check a request session. In the case of a session without login, the request may be made again to a FIDO RP service URL for performing login authentication. The user-end module 1 may display a screen for receiving personal information of the user according to the guide of a registration request page. The user-end module 1 may perform a user registration request by transmitting the personal information of the user input by the user to the RP server 2. The RP server 2 may receive the request from the user-end module 1 and perform a registration procedure. Here, the RP server 2 transmits necessary information of the RP server 2 or the user information receiving device 10 to the FIDO server 3 through the registration request process.

In operation S120, the FIDO server 3 may transmit a one-time password (OTP) which is randomly generated to authenticate the user. In operation S130, when the same OTP is returned from the user-end module 1, the FIDO server 3 may register the user. A short message service (SMS) OTP may be sent to a phone number received as the personal information of the user, and the user registration may be performed when the corresponding OTP number is input.

In operation S140, the FIDO server 3 may request the user-end module 1 to register feature information on the key security device 20, and in operation S150, the user-end module 1 may transmit an ACK signal or a NACK signal depending on whether the feature information is successfully registered. As an example, when the user-end module 1 successfully registers the feature information on the key security device 20, the user-end module 1 may transmit a first ACK signal, and when the user-end module 1 fails to register the feature information on the key security device 20, the user-end module 1 may transmit a first NACK signal.

A method of registering feature information on the key security device 20 will be described below with reference to FIG. 5.

FIG. 5 is a sequence diagram illustrating a method of registering user authentication information in the FIDO server 3 according to an embodiment.

Referring to FIG. 5, the user-end module 1 may register authentication information of the user on the FIDO server 3 by requesting FIDO registration from the FIDO server 3.

In operation S210, the user-end module 1 may request FIDO registration from the RP server 2, and in operation S220, the RP server 2 may request FIDO registration from the FIDO server 3. Here, operation S210 may be performed in response to a case in which the first ACK signal is generated in operation S150. In other words, the security system of the present disclosure may automatically request FIDO registration when the feature information is successfully registered on the key security device 20. In operation S230, the FIDO server 3 may transmit a challenge, user registration information, and information on the RP server 2 to the RP server 2 together with a response to the FIDO registration request. The challenge is any value of 16 bytes or more and may be information generated by the FIDO server 3. The user registration information may be identification information of the user that is provided in advance to the FIDO server according to the embodiment of FIG. 4.

In operation S240, the RP server 2 may request a public key from the user-end module 1. Here, the RP server 2 may transmit the challenge, the user registration information, the information on the RP server 2, and client data hash information. The challenge, the user registration information, the information on the RP server 2, and the client data hash information may be information required for the user-end module 1 to generate one pair of a private key and a public key. One pair of a private key and a public key may be referred to as a credential key pair.

According to a FIDO authentication protocol, one pair of a private key and a public key may be information generated by the key security device 20 only when user information input by a user matches user information stored in the device. According to an embodiment of the present disclosure, in the case of performing FIDO authentication registration, the operation of recognizing the user information may be omitted.

The feature information acquired in advance from the user according to the embodiment of FIG. 4 may be separately stored as user information input by the user and user information stored in the device, and thus it is possible to identify that the two pieces of user information match each other. As an example, the user information receiving device 10 may temporarily store the feature information in a first storage region and distinguish the feature information stored in the first storage region and the feature information received from the key security device 20 as the user information stored in the device and the user information input by the user, respectively. Accordingly, the user may skip the operation of inputting user information in a FIDO authentication registration process.

According to an embodiment, when a reference time or more elapses from the time of storing the feature information in the key security device 20 to the time of generating the public key and the private key, user information may be received again from the user, and feature information may be extracted again from the re-received user information to determine whether the feature information matches the feature information stored in the key security device 20.

In other words, when a short time elapses from the time of storing feature information in the key security device 20 to the time of generating a key pair, the security system of the present disclosure may determine whether it is permissible to generate a key pair using feature information stored in the devices, and when a long time elapses from the time of storing feature information in the key security device 20 to the time of generating a key pair, the security system may determine whether it is permissible to receive user information again and generate a key pair.

In operation S250, the user-end module 1 may return the generated public key to the RP server 1. At this time, the user-end module 1 may provide a credential identifier (ID) and attestation information to the RP server 2 together with the public key. The public key may be information that is electrically signed using the attestation private key, and the attestation information may include an attestation certificate issued by a certificate authority (CA).

In operation S260, the RP server 2 may provide user authentication information to the FIDO server 3. The user authentication information may include client information and attestation information provided in the format of JavaScript Object Notation (JSON).

In operations S270 and S280, when verification of the user authentication information is completed, the FIDO server 3 may return the result to the user-end module 1 through the RP server 2. Here, the FIDO server 3 may verify the certificate and verify the electrically signed information using the information attestation public key included in the certificate. When the verification is completed, the FIDO server 3 may map the public key, the credential ID, and the client data received from the user-end module 1 to the account of the user, completing FIDO authentication registration.

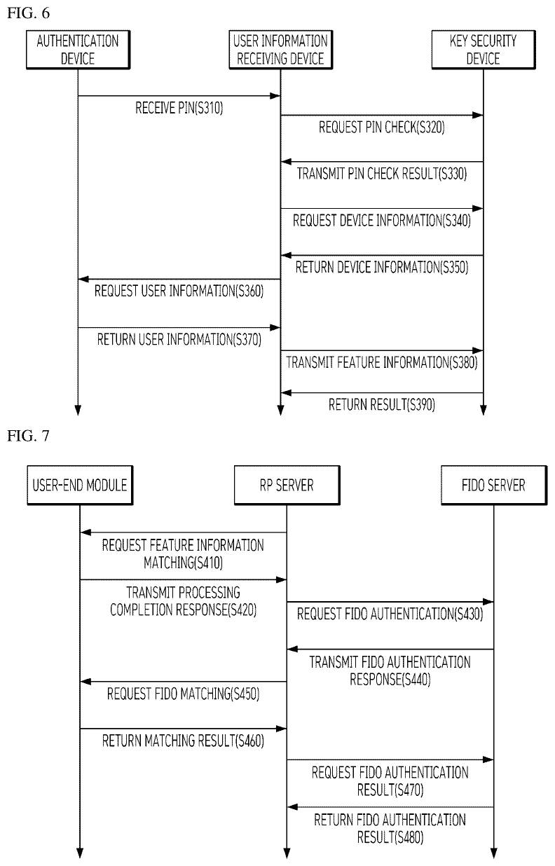

FIG. 6 is a sequence diagram illustrating a method of storing feature information in a key security device according to an embodiment.

Referring to FIG. 6, the user-end module 1 may include the authentication device 30, the user information receiving device 10, and the key security device 20 and transmit and receive data and information between the components to store feature information in the key security device 20.

In operation S310, the authentication device 30 may receive a PIN from the user and transmit the PIN to the user information receiving device 10. The authentication device 30 may be any type of device capable of receiving user information, and the PIN may be received through an input interface such as a keyboard, a touchpad, a mouse, or the like.

In operation S320, the user information receiving device 10 may transmit the PIN to the key security device 20 to request the key security device 20 to determine whether the PIN is identical to a previously stored PIN. When the key security device 20 is initialized, the user information receiving device 10 and the key security device 20 may perform an operation of setting a PIN in advance.

In operation S330, the key security device 20 may transmit the PIN identification result. When the PIN input by the user is identical to the previously stored PIN, an ACK signal may be transmitted, and when the PIN input by the user is different from the previously stored PIN, a NACK signal may be transmitted.

When the ACK signal is transmitted as the PIN identification result, the user information receiving device 10 may request device information from the key security device 20 in operation S340, and the key security device 20 may return device information thereof to the user information receiving device 10 in operation S350.

In operation S360, the user information receiving device 10 may request user information from the authentication device 30, and in operation S370, the authentication device 30 may acquire user information from the user and return the user information to the user information receiving device 10. As an example, when the user information is face information, the authentication device 30 may be a camera incorporated into the user information receiving device 10. In other words, the authentication device 30 and the user information receiving device 10 may be physically separated devices, but according to an embodiment of the present disclosure, the authentication device 30 and the user information receiving device 10 may be hardware that is included in one housing to perform different functions.

The user information receiving device 10 may extract feature information from the user information. The user information receiving device 10 may code the feature information according to an exemplified procedure of an API of the key security device 20. In a web-based service environment, feature information may be coded using a protocol, such as WebUSB, web human interface device (WebHID), or the like, capable of interfacing a web browser with a USB device. For the sake of compatibility, a transmission and reception data format may be in accordance with the concise binary object representation (CBOR) (request for comments (RFC) 8949) like the client to authenticator protocol (CTAP) standard.

According to an embodiment, the user information receiving device 10 may encrypt the feature information on the basis of the PIN and the device information. For example, the device information may be a serial number of the key security device 20, and the user information receiving device 10 may acquire an encryption key value by inputting the PIN and the device information to a preset function. The user information receiving device 10 may encrypt the feature information on the basis of the encryption key value, and the encryption key value may be deleted after the encryption is completed. Since the feature information of the present disclosure is generated on the basis of the device information and the user information, the user and the key security device 20 may be linked together. In other words, while conventional security authentication systems do not provide a method of linking the key security device 20 with the user, according to an embodiment of the present disclosure, user information and device information can be linked together to generate feature information.

In operation S380, the user information receiving device 10 may transmit the feature information to the key security device 20. Here, the transmitted feature information may be encrypted feature information, and the key security device 20 may decrypt the encrypted feature information and store the feature information in a storage region.

In operation S390, the key security device 20 may reply to the user information receiving device 10 that the feature information has been stored. When it is identified that the feature information has been stored, the user information receiving device 10 may perform a FIDO authentication registration procedure according to the embodiment of FIG. 5.

FIG. 7 is a sequence diagram illustrating a method of performing FIDO authentication in the security system according to an embodiment.

Referring to FIG. 7, when user authentication is requested by the user-end module 1 in the security system of the present disclosure, the user-end module 1 may transmit and receive data and information to and from the RP server 2 and the FIDO server 3 to complete FIDO authentication for a user.

In operation S410, when service access to the RP server 2 is requested by a user, the RP server 2 may request the user-end module 1 to perform feature information matching. The feature information request may be an operation of newly receiving user information through the authentication device 30, extracting feature information from the received user information, and then determining whether the newly extracted feature information corresponds to feature information stored in the key security device 20.

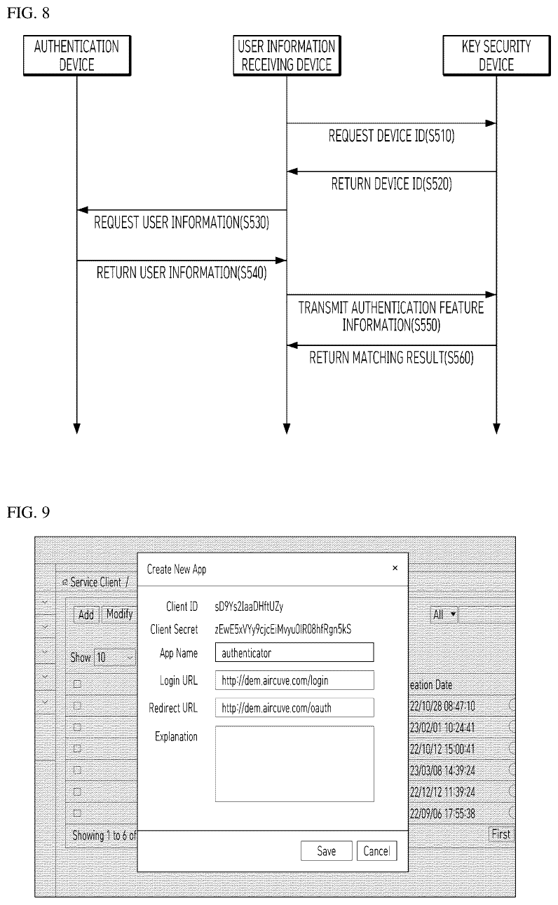

An embodiment in which the user-end module 1 performs feature information matching will be described below with reference to FIG. 8.

In operation S420, the user-end module 1 may process an operation of comparing the newly received feature information with feature information that has already been registered on the key security device 20 and transmit a processing completion response to the RP server 2. Here, the processing completion response may include a second ACK signal indicating a matching success response or a second NACK signal indicating a matching failure response.

In operation S430, when the second ACK signal is received, the RP server 2 may request FIDO authentication so that FIDO authentication may be performed. In operation S440, the FIDO server 3 may respond to the FIDO authentication request. Here, the RP server 2 and the FIDO server 3 may transmit and receive a challenge.

In operation S450, the RP server 2 may request FIDO matching from the user-end module 1. Here, the RP server 2 may transmit information on the RP server 2 and client data hash information to the user-end module 1. The user-end module 1 may verify whether the user is the owner of a private key matching the information on the RP server 2. When the verification is successful, the user-end module 1 may electronically sign for the challenge using the private key to generate an assertion signature.

According to a FIDO authentication protocol, the assertion signature may be information that is generated by the key security device 20 only when the user information input by the user matches user information stored in the device. According to an embodiment of the present disclosure, in the case of performing FIDO authentication, the operation of recognizing the user information may be omitted.

Here, the feature information acquired in advance from the user may be separately stored as user information input by the user and user information stored in the device, and thus it is possible to identify that the two pieces of user information match each other. As an example, the user information receiving device 10 may temporarily store the feature information in a first storage region and distinguish the feature information stored in the first storage region and the feature information received from the key security device 20 as the user information stored in the device and the user information input by the user, respectively. Accordingly, the user may skip the operation of inputting user information in a FIDO authentication registration process. According to an embodiment, when a reference time or more elapses from the time at which the key security device 20 determines whether the two pieces of feature information match each other to the time of generating the assertion signature, user information may be received again from the user, and feature information may be extracted again from the re-received user information to determine whether the feature information matches the feature information stored in the key security device 20.

In other words, when a short time elapses from the time at which the key security device 20 determines whether the two pieces of feature information match each other to the time of performing FIDO authentication according to the FIDO protocol, the security system of the present disclosure may determine whether it is permissible to generate an assertion signature using feature information stored in the devices, and when a long time elapses from the time at which the key security device 20 determines whether the two pieces of feature information match each other to the time of performing FIDO authentication, the security system may determine whether it is permissible to receive user information again and generate an assertion signature.

In operation S460, the user-end module 1 may return the matching result and transmit the assertion signature and authenticator data to the RP server 2. In operation S470, the RP server 2 may transmit the client data, the assertion signature, and the authenticator data to the FIDO server 3, and the FIDO server 3 may verify the received data. As an example, the FIDO server 3 may decrypt the assertion signature using the public key matching the user account to determine whether the received data corresponds to the challenge that has been transmitted by the FIDO server 3.

When the verification is successful, in operation S480, the FIDO server 3 may return a FIDO authentication result in response to the request. Here, as the FIDO authentication result, a token or cookie for authorization may be transmitted to the user-end module 1 through the RP server 2. The token for authorization may be referred to as an access token that represents that the user is allowed to access the RP server 2.

FIG. 8 is a sequence diagram illustrating a method of acquiring a matching result between authentication feature information and feature information from the key security device 20 according to an embodiment.

Referring to FIG. 8, the user-end module 1 may include the authentication device 30, the user information receiving device 10, and the key security device 20 and transmit and receive data and information between the components to determine whether feature information corresponds to authentication feature information.

In operation S510, the user information receiving device 10 may request device information from the key security device 20, and in operation S520, the key security device 20 may return the device information of the key security device 20 to the user information input device.

In operation S530, the user information receiving device 10 may request user information from the authentication device 30, and in operation S540, the authentication device 30 may acquire user information from the user and return the user information to the user information receiving device 10. As an example, when the user information is face information, the authentication device 30 may be a camera incorporated into the user information receiving device 10. In other words, the authentication device 30 and the user information receiving device 10 may be physically separated devices, but according to an embodiment of the present disclosure, the authentication device 30 and the user information receiving device 10 may be hardware that is included in one housing to perform different functions.

The user information receiving device 10 may extract authentication feature information from the user information. The user information receiving device 10 may code the authentication feature information according to an exemplified procedure of an API of the key security device 20. In a web-based service environment, authentication feature information may be coded using a protocol, such as WebUSB, WebHID, or the like, capable of interfacing a web browser with a USB device. For the sake of compatibility, a transmission and reception data format may be in accordance with the CBOR (RFC8949) like the CTAP standard.

According to an embodiment, the user information receiving device 10 may encrypt the authentication feature information on the basis of the device information. For example, the device information may be the serial number of the key security device 20, and the user information receiving device 10 may acquire an encryption key value by inputting the device information to a preset function. The user information receiving device 10 may encrypt the authentication feature information on the basis of the encryption key value, and the encryption key value may be deleted after the encryption is completed.

In operation S550, the user information receiving device 10 may transmit the authentication feature information to the key security device 20. Here, the transmitted authentication feature information may be encrypted feature information, and the key security device 20 may decrypt the encrypted authentication feature information and compare the authentication feature information with feature information stored in a storage region. As an example, when a plurality of pieces of feature information are separately stored in the storage region of the key security device 20, the key security device 20 may compare each piece of the feature information code with the code of the received authentication feature information. When a piece of the feature information code is identical to the authentication feature information, it may be determined that there is feature information matching the authentication feature information.

In operation S560, the key security device 20 may return the matching result to the user information receiving device 10. When the key security device 20 succeeds in the match, the key security device 20 may transmit a second ACK signal to the user information receiving device 10, and when the key security device 20 fails in the match, the key security device 20 may transmit a second NACK signal to the user information receiving device 10. When the second ACK signal is received, the user information receiving device 10 may perform FIDO authentication according to the FIDO protocol. FIGS. 9 and 10 are diagrams illustrating an embodiment of registering information on the RP server 20 and a user on the key management server 4.

Referring to FIG. 9, the RP server 2 may receive information required for registration from a security manager and register information on the RP server 2 and a user on the key management server 4. Here, the RP server 2 corresponds to a client on the basis of the key management server 4, and a client ID and a client secret may be specified in advance as information corresponding to the RP server. The security manager registers information (a service login URL, a secret key, and the like) on the RP server, which will perform a FIDO authentication request, in advance and sets a server certificate or security key, making it possible to verify whether the FIDO authentication request is made by a trusted RP server.

According to FIG. 10, the key management server 4 may receive an ID/password and personal information of the user.

FIG. 11 is a set of views illustrating an embodiment of selecting a type of authentication in the RP server 2 according to an embodiment.

Referring to FIG. 11, when a specific user tries to access the URL of the RP server 2 registered according to FIG. 9, the user may be authenticated first by entering a registered ID/password of the user on the login page and authenticated second by the key security device 20. Here, when the key security device 20 is not connected to the user information receiving device 10 or is initialized, authentication via the key security device 20 (FIDO2 token) may not be activated.

FIG. 11 may be a web screen that is output through the user information receiving device 10 according to an embodiment of the present disclosure and a web screen for performing an authentication function of the RP service module via an RP server function applied to a service login page. In the screen, the user may connect his or her key security device 20 to the user information receiving device 10 and select an authentication method to perform self-identification.

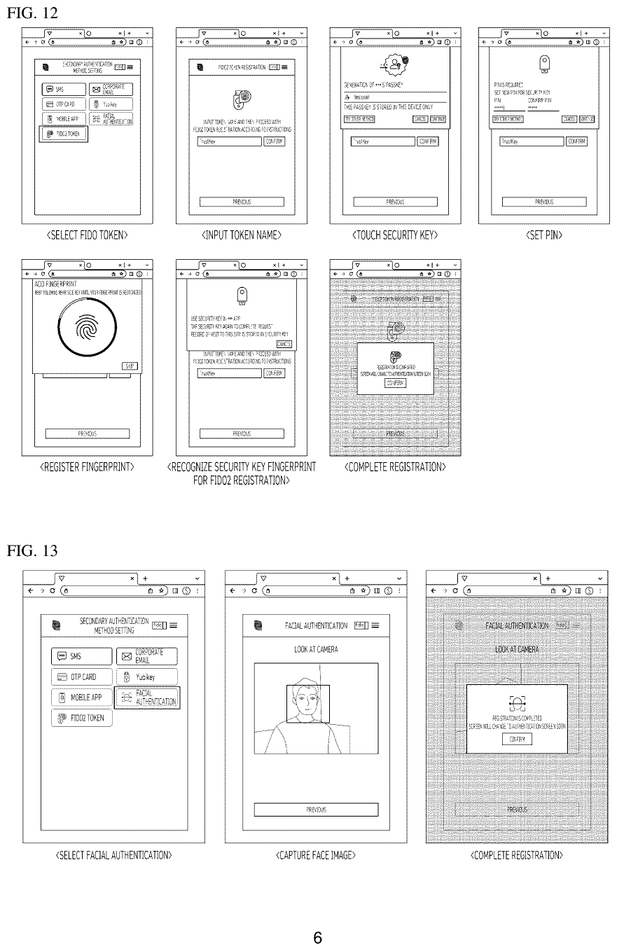

FIG. 12 is a set of views illustrating an embodiment of registering feature information in the key security device 20 and storing user authentication information corresponding to the feature information in the FIDO server 3.

Referring to FIG. 12, when authentication via the key security device 20 is selected by the user, a token name of the key security device 20 may be input. According to an embodiment, the key security device 20 may be integrated with the authentication device 30 into one housing. As an example, the key security device 20 may be integrated into one device with the authentication device 30 to which fingerprint information is input.

When fingerprint information is input as user information by the user, the security system of the present disclosure may register FIDO authentication for the user information using the methods described above with reference to FIGS. 4 to 6.

FIG. 13 is a set of views illustrating an embodiment of registering feature information in the key security device 20 using a different authentication method than in FIG. 12.

Referring to FIG. 13, the key security device 20 may be connected to the user information receiving device 10 and receive a different type of user information from the user information of FIG. 12 through the authentication device 30 to register feature information on the key security device 20.

As an example, the user information receiving device 10 may extract first feature information from fingerprint information to store the first feature information in the key security device 20 and may extract second feature information from face information to store the second feature information in the key security device 20.

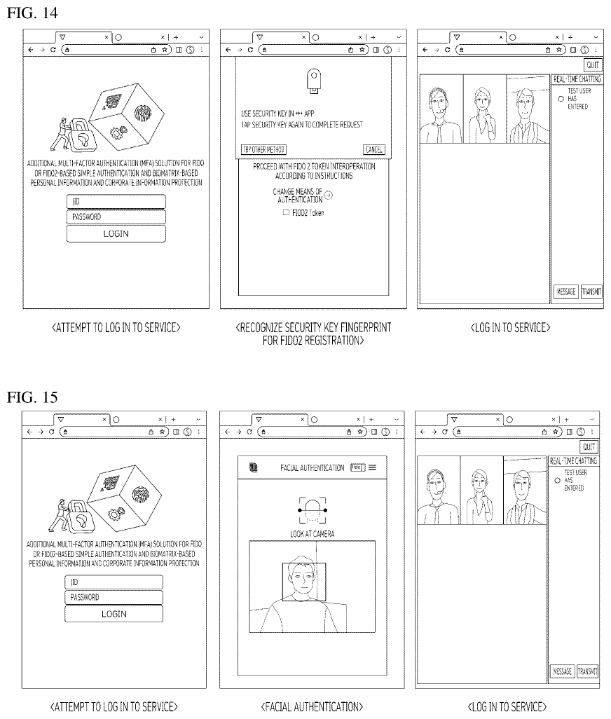

FIGS. 14 and 15 are sets of views illustrating different embodiments of authenticating a user.

According to FIGS. 14 and 15, the user information receiving device 10 may receive any one of different types of user information and compare authentication feature information extracted from the user information with feature information stored in the key security device 20. When the comparison result indicates that feature information matching the authentication feature information is stored, the user can log in to a service. The embodiment of performing FIDO authentication when a user provides user information for service login has been described above with reference to FIGS. 7 and 8, and detailed description thereof will be omitted.

Exemplary embodiments have been disclosed in the drawings and specification. Although specific terms have been used for describing the embodiments herein, the terms have been used for the purpose of describing the technical spirit of the present disclosure rather than limiting the scope of the present disclosure described in the claims. Therefore, those of ordinary skill in the present technical field should understand that various modifications and other equivalent embodiments can be made from the embodiments. Therefore, the technical scope of the present disclosure should be determined according to the technical spirit of the following claims.

### INDUSTRIAL APPLICABILITY

In a security system according to an embodiment of the present disclosure, a user inputs user information through a terminal that is currently accessing the security system, and thus additional security control can be performed according to the location of the terminal. Also, a key security device interoperates with a smartphone through a simple user information input interface, such as a fingerprint sensor, a camera, a keypad, or the like, or is installed in the form of an application and executed, and thus a fast identity online (FIDO) standard security system can be applied in a legacy information technology (IT) environment.

1. An operating method of a security system for authenticating a user on the basis of fast identity online (FIDO), the operating method comprising:
receiving first user information through a user information receiving device connected to a key security device;
storing feature information generated on the basis of the first user information in the key security device;
receiving second user information of which authentication is requested through the user information receiving device; and
receiving a token for allowing user access from a FIDO server in response to a case in which the key security device determines that authentication feature information generated on the basis of the second user information matches the feature information.

2. The operating method of claim 1, wherein the receiving of the first user information comprises:
receiving the first user information through a first authentication device connected to the user information receiving device; and
receiving second user information through a second authentication device of a different type than the first authentication device, and the storing of the feature information in the key security device comprises:
matching the first user information with the first authentication device to generate a 1-1 security key;
matching the second user information with the second authentication device to generate a 1-2 security key; and
storing the 1-1 security key and the 1-2 security key in different storage regions.

3. The operating method of claim 1, wherein the storing of the feature information in the key security device comprises:
generating encrypted feature information on the basis of device information of the key security device and the first user information; and
decrypting the encrypted feature information through the key security device.

4. The operating method of claim 3, wherein the encrypted feature information is generated by the user information receiving device or a relying party (RP) server which is in communication with the user information receiving device, and
after the feature information is transmitted to the key security device, the feature information at least temporarily stored in the user information receiving device and the RP server is discarded.

5. The operating method of claim 4, further comprising blocking access from the user information receiving device and the RP server to a storage region of the key security device in which the feature information is stored.

6. The operating method of claim 1, further comprising:
in response to a case in which the feature information is stored in the key security device, transmitting a first ACK signal to a relying party (RP) server; and
providing user authentication information from the RP server to the FIDO server in response to the first ACK signal.

7. The operating method of claim 6, wherein the transmitting of the first ACK signal comprises providing a public key generated on the basis of the feature information to the RP server.

8. The operating method of claim 1, wherein the receiving of the second user information comprises:
identifying a type of authentication which is requested by a user from the user information receiving device; and
receiving the second user information from an authentication device corresponding to the type of authentication.

9. The operating method of claim 1, wherein the receiving of the token comprises:
acquiring device information of the key security device connected to the user information receiving device; and
generating the authentication feature information on the basis of a type of authentication device, device information of the key security device, and the second user information.

10. The operating method of claim 9, wherein the receiving of the token comprises:
comparing, by the key security device, the authentication feature information with the feature information; and
when it is determined through the comparison that the feature information corresponds to the authentication feature information, transmitting a second ACK signal to a relaying party (RP) server.

11. A security system comprising:
a relying party (RP) service module configured to generate feature information from first user information received through an authentication device; and
a key security device connected to the RP service module to store the feature information and configured to determine whether authentication feature information generated on the basis of second user information, of which authentication is requested through the authentication device, matches the feature information,
wherein the key security device blocks access from an external device to a storage region in which the feature information is stored.

12. The security system of claim 11, wherein the RP service module receives a token for allowing user access from a fast identity online (FIDO) server in response to a case in which it is determined that the authentication feature information matches the feature information.

13. The security system of claim 11, wherein the RP service module receives the first user information through a first authentication device to match the first user information with the first authentication device and generate a 1-1 security key and receives second user information through a second authentication device of a different type than the first authentication device to match the second user information with the second authentication device and generate a 1-2 security key, and the key security device stores the 1-1 security key and the 1-2 security key in different storage regions.

14. The security system of claim 11, wherein the RP service module generates an encrypted feature information on the basis of device information of the key security device and the first user information and transmits the encrypted feature information to the key security device, and
the key security device decrypts the encrypted feature information.

15. The security system of claim 14, wherein, after transmitting the feature information to the key security device, the RP service module discards the feature information which is at least temporarily stored.

16. The security system of claim 11, wherein, in response to a case in which the feature information is stored, the key security device transmits a first ACK signal to the RP service module, and
the RP service module provides user authentication information to a fast identity online (FIDO) server in response to the first ACK signal.

17. The security system of claim 16, wherein the key security device provides a public key generated on the basis of the feature information to the RP service module.

18. The security system of claim 11, wherein the RP service module identifies a type of authentication requested by a user from the user information receiving device and receives the second user information from an authentication device corresponding to the type of authentication.

19. The security system of claim 11, wherein the key security device acquires device information of the key security device and generates the authentication feature information on the basis of a type of authentication device, device information of the key security device, and the second user information.

20. The security system of claim 11, wherein the key security device compares the authentication feature information with the feature information, and when it is determined through the comparison that the feature information corresponds to the authentication feature information, transmits a second ACK signal to the RP service module.
